(19) United States
(12) Patent Application Publication
(10) Pub. No.: US 2026/0318153 A1
(43) Pub. Date: Oct. 15, 2026

(54) PLATFORM LADDER APPARATUS

(71) Applicant: STÅSÄKER AB, TÖREBODA (SE)

(72) Inventor: Lars Gustafsson, TÖREBODA (SE)

(73) Assignee: Ståsäker AB, TÖREBODA (SE)

(21) Appl. No.: 19/483,493

(22) PCT Filed: May 15, 2024
(86) PCT No.: PCT/EP2024/063420

§ 371 Date: Nov. 11, 2025

(30) Foreign Application Priority Data
May 17, 2023 (EP) 23173876.6

(51) Int. Cl. E06C 1/393; E06C 1/12; E06C 1/397; E06C 7/18; E06C 7/42

(52) U.S. Cl. CPC E06C 1/393; E06C 7/182; E06C 7/185; E06C 1/12; E06C 1/397; E06C 7/423

(57) ABSTRACT

There is disclosed a ladder platform apparatus (2), comprising a ladder (4), a working platform (20), and a foldable safety railing (40). Locking devices (100; 200) are arranged to lock railing posts (44) of the safety railing (40) in their raised position of use. Each locking device (100; 200) has a locking member (102; 202) movable between a non-locking position in which an associated railing post (44) is free to rotate in relation to the working platform (20), and a locking position in which the locking member (102; 202) is in engagement with a front side and a rear side, respectively, of the railing post (44), and in which the locking member (102; 202) is prevented from rotating in relation to the working platform (20), thereby preventing the railing post (44) from rotating away from its locked raised position.

### TECHNICAL FIELD

The present invention generally relates to the field of working platforms, and more specifically to ladders provided with a working platform for use by persons who need to carry out tasks on elevated levels.

### BACKGROUND

Work on constructions, houses and the like on elevated levels is often performed by the use of ladders, different types of vertical platform structures, sky lifts, and for bigger works by the use of scaffolding arrangements. Each of these has its advantages and drawbacks depending on the type of work, especially depending on the time required for the work. Ladders are cheap, they can be quickly put in position but often result in serious accidents, why many companies do not allow work being performed by persons standing on a ladder except from a very low level. Scaffold arrangements and free-standing platform arrangements have a higher degree of stability and safety, but they require time and effort for their mounting and for their adjustment and repositioning during the work.

The prior art does not offer any solution for arranging a safe and stable work platform for performing work on an elevated level, which can be installed in a short time, which is relatively cheap, which is suitable for less time-consuming works and which may be erected and repositioned by one person only.

In applicant's EP 3 293 345 A1, EP 3 572 610 A1, and EP 3 995 665 A1 there is disclosed a foldable platform ladder apparatus which may be arranged in a simple and quick manner, which is safe in terms of stability, and which can be easily moved between different working positions. The platform ladder apparatus comprises a ladder, a platform pivotably connected to the ladder, and a foldable safety railing. The platform ladder apparatus is designed to lean against a wall with a distal front side of the platform located close to the wall, and with the platform with an angle in relation to the ladder. The apparatus provides an enhanced stability and security compared to other known solutions, while at the same time being fully foldable to a transport position. In short, it is simple as a ladder and safe and stable as a scaffold. While this known platform ladder apparatus offers many advantages compared to other known alternatives, there is still room for improvements.

### SUMMARY OF INVENTION

An object is to provide a platform ladder apparatus of the general type disclosed in applicant's above mentioned applications, which is improved in terms of stability, ease of handling, and the time required for unfolding and preparing the apparatus for use.

According to one aspect of the inventive concept, there is provided a ladder platform apparatus, comprising:
a ladder;
a working platform having a rear side at which the working platform is rotatably connected to the ladder, and an opposite front side;
a foldable safety railing having a left and a right lockable railing post rotatably mounted at a left side and a right side, respectively, of the working platform for rotation about a post pivot axis located below the working platform between a folded transport position, and a lockable raised position in which each railing post presents an upper part located above the working platform and a lower part located below the working platform; and
a left and a right locking device associated with the left railing post and the right railing post, respectively, each locking device comprising a movable locking member which has a front engagement part and a rear engagement part spaced from the front engagement part, and which is arranged to be moved in relation to the working platform as well as its associated railing post between
   a non-locking position in which the associated railing post is free to rotate about the post pivot axis in relation to the working platform, and
   a locking position in which the front engagement part and the rear engagement part of the movable locking member is in engagement with a front side and a rear side, respectively, of the upper part of the associated railing post, and in which the locking member is prevented from rotating in relation to the working platform about the post pivot axis, thereby preventing the railing post from rotating about its post pivot axis away from its locked raised position.

The inventive concept provides a quick and simple way to lock and unlock the foldable safety railing, and at the same time provides increased stability to the safety railing in its raised position of use. The movable locking member, when in its locking position, acts as a stable mechanical connection or “bridge member” between the platform and the railing post. The structure of the locking device is such that the movable locking member is prevented from rotating in the front-rear direction at least when in its locking position. When in its locking position, it will therefore effectively prevent the railing post from pivoting about its post pivot axis. Together, the locking devices of the apparatus will thereby effectively lock the safety railing in its raised position of use.

The movable locking member is movable, such as manually movable, between its non-locking position and its locking position. The arrangement is preferably such that this movement is mechanically guided, to ensure that the movement is done correctly, and especially to ensure that the correct locking position is obtained every time. The inventive concept provides two alternatives for providing such a mechanical guidance of the movable locking member, in the following termed the rotatable embodiment and the telescopic embodiment. The mechanical guide should preferably also ensure that the movable locking member is always connected to the apparatus.

In preferred embodiments, each locking device is provided with security means for securing the movable locking member in its locking position, in order to ensure that the movable locking member is not accidentally moved to its non-locking position during use of the apparatus. Such security means may include a displaceable locking pin. The security means may be of self-locking type, e.g. a snap-lock, such that the movable locking member is automatically secured in its locking position in direct response to the locking member being moved into its correct locking position.

In the rotatable embodiment, each locking device further comprises a hinge mechanism which forms the mechanical movement guide for the locking member, and by which the movable locking member is rotatably connected, directly or indirectly, to the platform for rotation about a hinge axis extending in a rear-front direction of the platform. In the rotatable embodiment, the associated railing post is preferably out of engagement with the movable locking member in the non-locking position, and is preferably located inside the boundaries of the platform in its non-locking position, such that the associated railing post can be freely pivoted without being hindered by the locking device during unfolding and folding of the apparatus. During the locking procedure, the associated railing post is received between the front engagement part and the rear engagement part of the rotatable locking member in response to the locking member being rotated about the hinge axis towards the railing post. In the rotatable embodiment, the hinge mechanism is structured and arranged to always prevent the movable locking member from rotating about the post pivot axis. Thereby, the locking member, when in its locking position, will effectively prevent the associated post from pivoting in the front-rear direction.

A stationary hinge part of the hinge mechanism may typically be secured to the upper side of the platform, close to the boundary of the platform and adjacent the associated railing post. A rotatable hinge part supports the movable locking member, preferably in such a way that the front and rear engagement parts of the locking member, when the locking member is in its locking position, are located laterally outside the platform boundary in engagement with the railing post. In the folded transport position of the apparatus, the rotatable locking member may be in a transport position, rotated towards the platform, in order not to be in the way when the apparatus is folded into its transport position. The movable locking member and the rotatable hinge part may be formed in one piece, such as a one-piece member of stainless steel.

In the rotatable embodiment, in order to ensure that the rotatable locking members of the locking devices do not disturb the folding and unfolding of the apparatus, each hinge mechanism may be biased towards the non-locking position of the locking member, for instance by one or more springs acting on the rotatable hinge part.

In a preferred variant of the rotatable embodiment, the rotatable locking member comprises an elongate rigid member having a cross section in the shape of a U, wherein legs of the U form the front engagement part and the rear engagement part, respectively, of the locking member. The dimensions of the U typically correspond to the cross-sectional dimensions of the railing post. The railing post is received into an open side of the U in response to the locking member being rotated towards railing the post. In such an embodiment, the base of the U may optionally be used to form a rotational stop for the locking member to define the correct locking position. Other rotational stop means may be used instead or in addition. In such embodiments, the front side and the rear side of the railing post may be provided with guide means, such as guide ramps, for guiding the post correctly into the C-shaped rotatable locking member when the latter is rotated towards the railing post.

In its most basic embodiment, each locking device is structured to prevent the associated railing post from pivoting about its post pivot axis, and to hold the railing post in a stable manner in the rear-front direction during the use of the apparatus. This function of the locking devices is thus to lock the entire safety railing in its folding direction (rear-front). In use of the apparatus, a user may however often lean on the safety railing in lateral directions. In order to also stabilize the safety railing in lateral directions, the movable locking member may have an additional engagement element (optional), wherein, when the locking member it is in its locking position in engagement with the associated railing post,
the locking member is prevented also from moving laterally away from the platform, and
said additional engagement element is in engagement with the railing post for preventing the railing post from moving laterally away from the locking member and, thereby, laterally away from the platform.
The expression “laterally away” refers to a direction in a plane parallel with the post pivot axis and the railing post.

Such an additional engagement element may be structured and arranged, when the locking member is in its locking position, to be in engagement with the upper part of the railing post (i.e. above the platform).

In the rotatable embodiment, such a further engagement element may include a displaceable engagement member, such as a displaceable locking pin, which is mounted on the front or rear engagement part of the locking member and which is displaceable between an unlocking position in which it is not in engagement with the railing post, and a locking position in which it is in engagement with the associated railing post for preventing the railing post from moving laterally away from the platform. The engagement with the railing post may be an engagement on the laterally outer side of the railing post, or an engagement in a hole or opening in the post. It will be appreciated that such a locking pin may have dual purposes: to secure the locking member in its locking position as described above, and to take up forces acting on the railing post laterally away from the platform such that the locking member locks the railing post in at least three directions (front, rear, outwards).

In the rotatable embodiment, when including the above-mentioned optional additional engagement element for preventing laterally movement of the railing post and for laterally stabilizing the railing post, the rotatable locking member should be prevented from rotating beyond its locking position laterally away from the platform. This may be accomplished by each locking device including a rotational stop means defining a rotational stop for the rotatable locking member. Such rotational stop means may be adjustable. The rotational stop means may be implemented by additional or alternative means, such as by separate stop means, and/or by using a platform rim (potentially reinforced) as a rotational stop means. The rotational stop means may be arranged to engage directly with the movable locking member. However, in preferred embodiment, the rotational stop means is arranged to engage with the rotational hinge part of the hinge mechanism.

In a preferred variant of the rotatable embodiment, the further engagement element is a displaceable snap-locking pin, which is biased towards its locking position. In such a variant, the railing post may be provided with at least one guide ramp arranged to interact with the tip of the locking pin and automatically, when the locking member is rotated towards the railing post, temporarily move the locking pin to its non-locking position, such that the locking pin automatically snap-lock the railing post when the latter has reached its correct locked position.

In the telescopic embodiment, the posts are used as mechanical guides for the movable locking members. In the telescopic embodiment, the movable locking member is a linearly displaceable or slidable locking member and is slidably supported by the associated railing post for linear movement along the railing post between the non-locking position and the locking position. The locking member is located closer to the platform in the locking position compared to the non-locking position. According to inventive concept, the arrangement is such that the locking member, when it is in its locking position, is prevented from moving or rotating in a plane perpendicular to the post pivot axis. In the telescopic embodiment, this may be implemented by the slidable locking member, when it is in its locking position, being in mechanical engagement with stationary engagement means which are directly or indirectly secured to the platform. In some embodiment, a platform rim may be used to form such engagement means. In some embodiments, the displaceable locking member and/or the platform rim is provided with one or more locking grooves which form a rotational lock for the locking member when it is displaced into its locking position. In other embodiments, the platform may be provided with separate engagement means, such as upwardly protruding locking pins, for engagement with the locking member when the latter is displaced towards the platform.

As for the rotatable embodiment described above, also the telescopic embodiment is preferably provided with means for stabilizing the locked posts also laterally in a direction outwards from the platform. In the telescopic embodiment, such engagement means may be implemented by the displaceable locking member being a tubular locking member having an inner cross-section essentially corresponding to the outer cross-section of the associated railing post. The front side and the rear side of the tubular locking member form the front engagement part and the rear engagement part, respectively. The laterally outer side of the tubular locking member form the additional engagement for preventing movement of the railing post outwards away from the platform. In some embodiments, the tubular locking member is in the form of a closed tube, for instance with a rectangular or quadratic cross-section. In other embodiments, the tubular locking member can be partly open laterally outwards from the platform, as long as it comprises one or more parts in engagement with the laterally outer side of the railing post. For instance, the cross-section of the tubular locking member could have the form of a C.

As for the rotatable embodiment, also the telescopic embodiment may preferably be provided with security means for securing the locking member in its locking position. Such means may be implemented by a displaceable, preferably spring-loaded locking pin.

The safety railing comprises at least the two above-mentioned lockable railing posts, one to the left and one to the right. However, the safety railing preferably comprises additional railing posts. In preferred embodiments, the safety railing comprises four railing posts: a left and a right front railing post, and a left and a right rear railing post. At least one railing post on each side should be lockable by a locking device as defined above. The lockable railing posts could include the two front railing posts, and/or the two rear railing posts, or other combinations. In some embodiments, all railing post are lockable by its own associated locking device. In preferred embodiments, only the left and the right front railing post are provided by an associated locking device. Locking one post on each side indirectly rotationally locks other post on that side also via interconnecting horizontal railings. Also, the two rear posts are preferably connected to each other via a laterally directed horizontal railing bar which gives increased lateral stability to the rear posts. The front posts, on the other hand, may not always be interconnected to each other by such a laterally directed horizontal railing bar. By arranging the locking device at the front posts, the locking post may give an increased lateral stability to the front posts. The movable locking member, when in its locking position, is preferably located at a lower end of the upper part of the associated railing post, at a distance from a top end of the railing post. In preferred embodiments, the locking member is located close to the platform in its locking position. In embodiments where the platform comprises an edge rim to the left and to the right, the locking member may typically be located just above the edge rim in the locking position. As to the lateral location of the locking member, since the pivotable railing posts are typically pivotably arranged to the left and to the right of the platform, laterally outside the boundaries of the platform, it follows that the front and rear engagement parts of the movable locking member are preferably also located laterally outside the platform in the locking position.

### DETAILED DESCRIPTION OF PREFERRED EMBODIMENTS

The inventive concept, some non-limiting embodiments, and further advantages of the inventive concept will now be described with reference to the drawings in which:

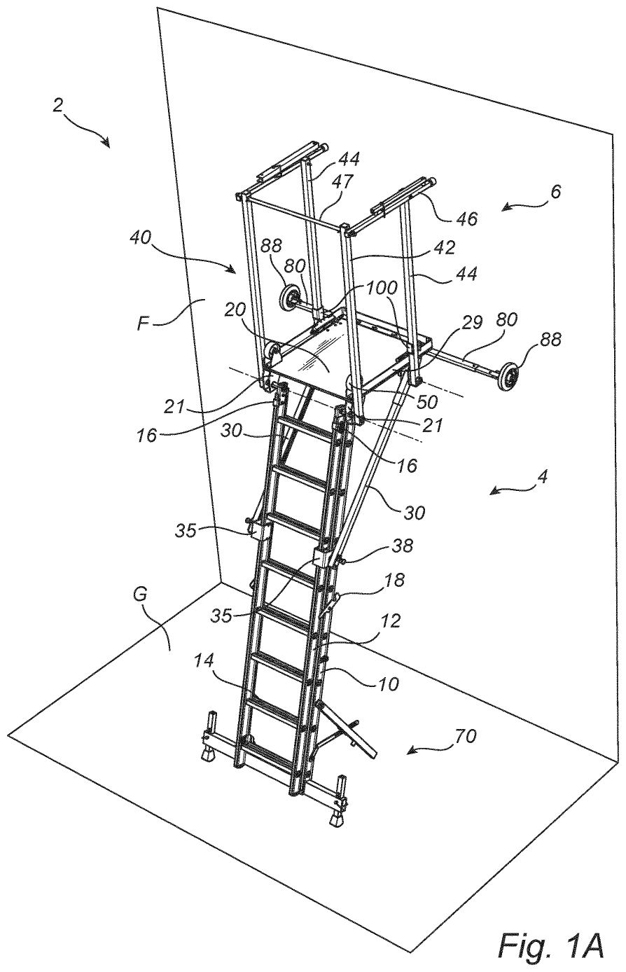

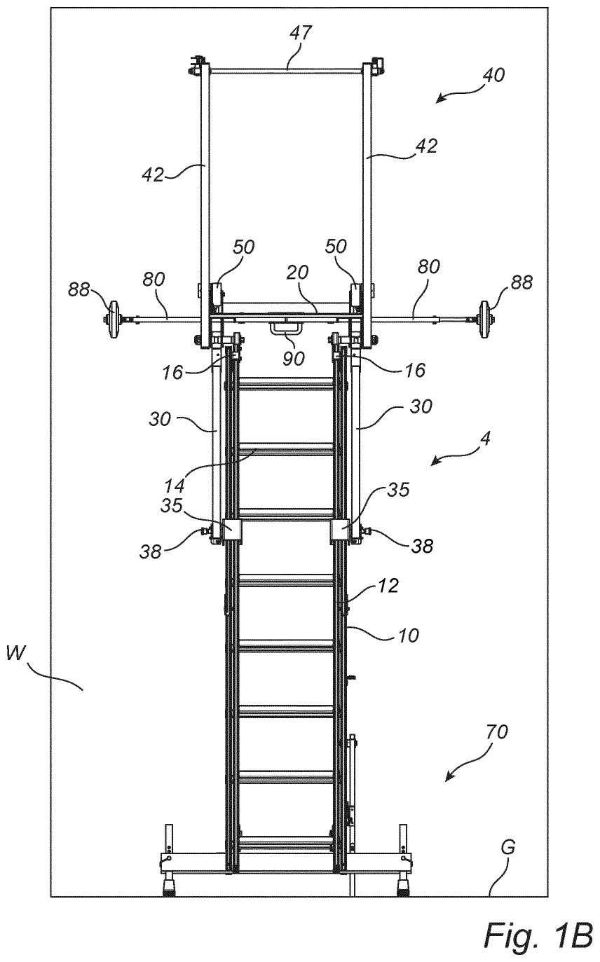

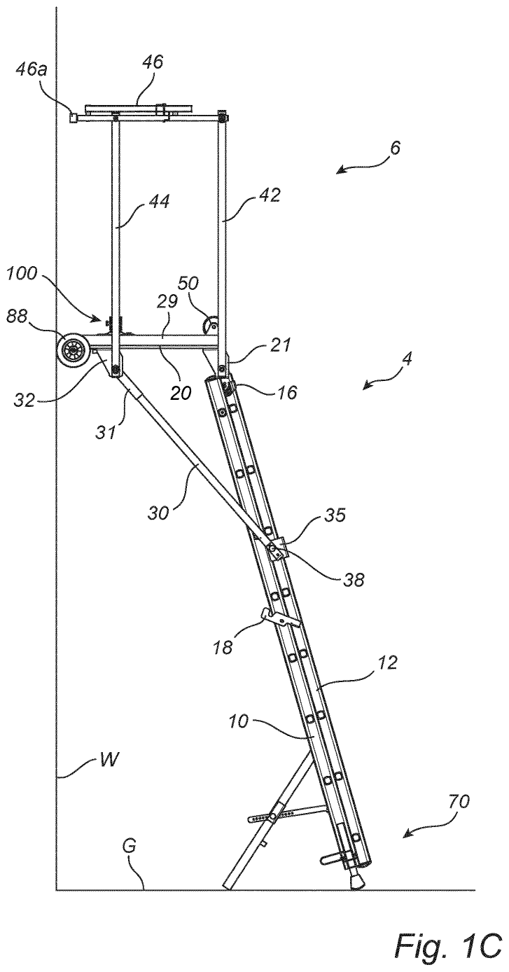

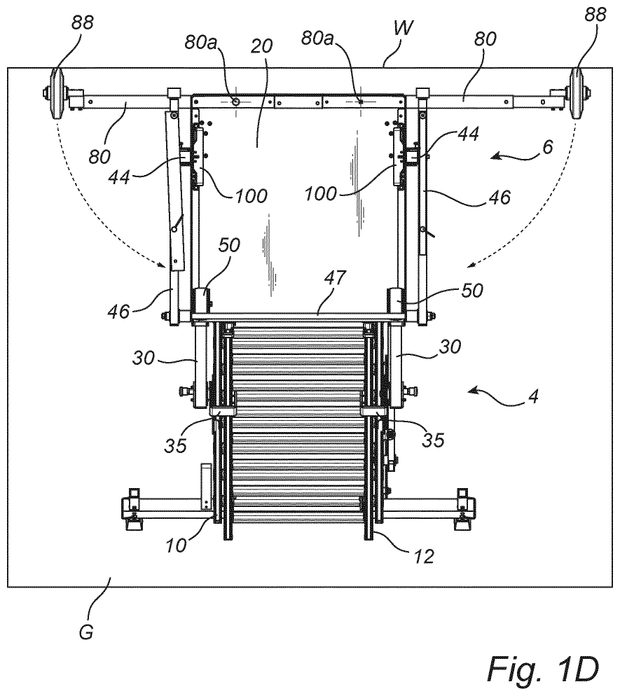

FIG. 1A to 1D show an embodiment of a platform ladder apparatus, in use against a wall.

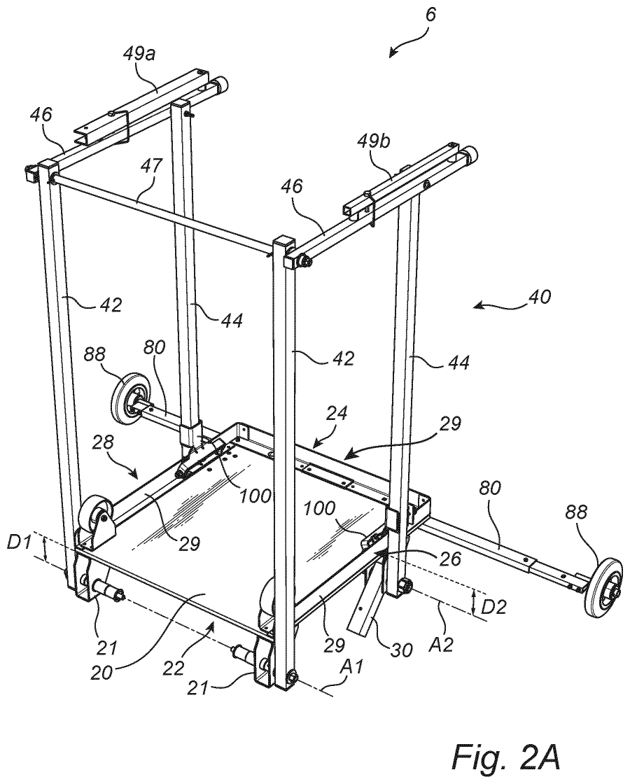

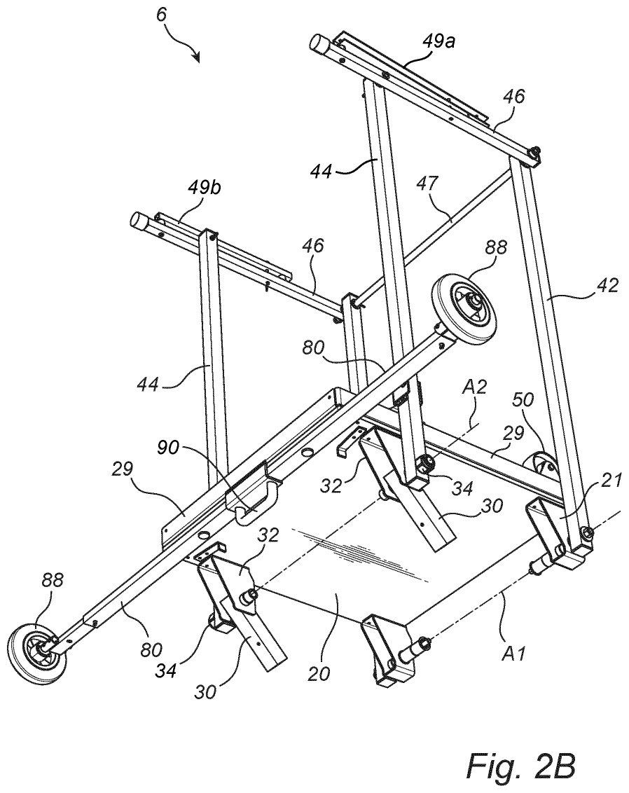

FIGS. 2A & 2B show a platform assembly of the platform ladder apparatus in FIG. 1.

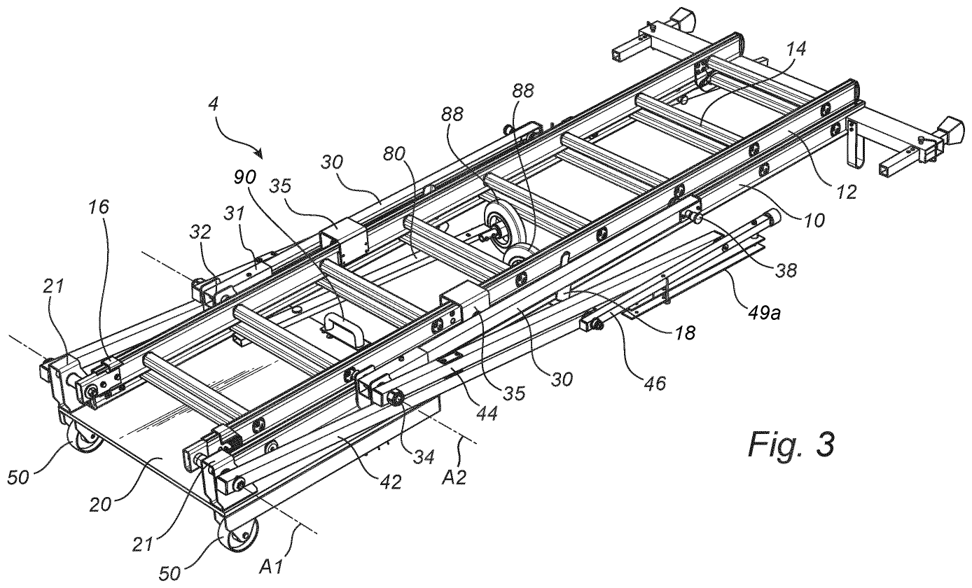

FIG. 3 shows the platform ladder apparatus in FIG. 1 in a folded transport position.

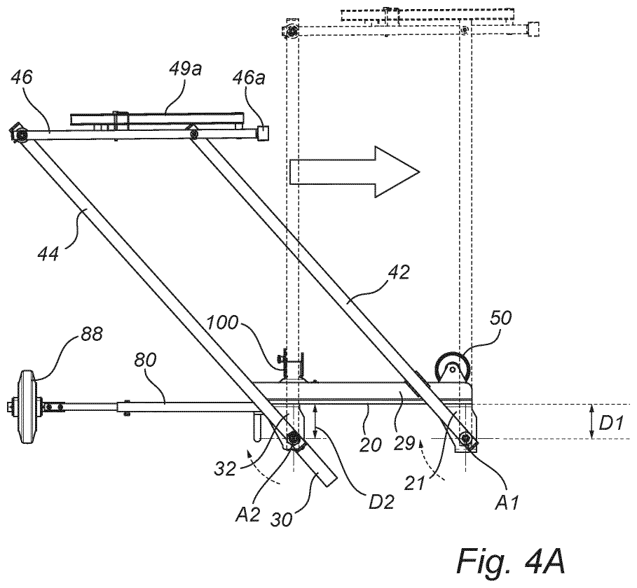

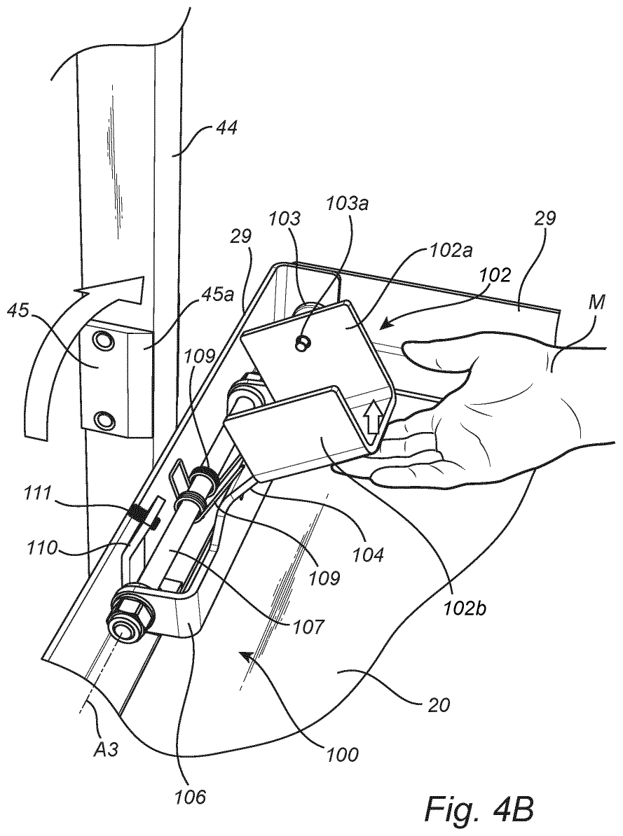

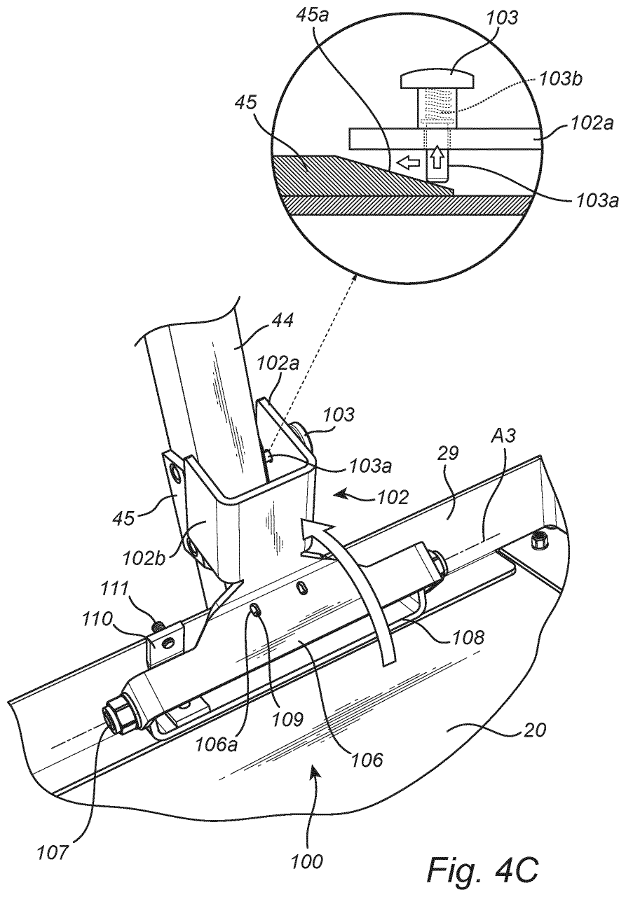

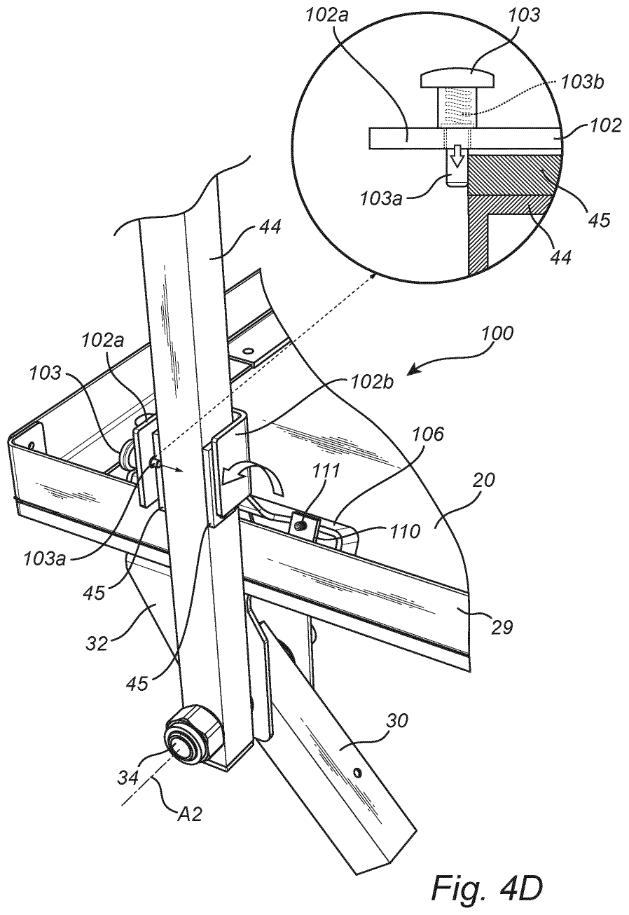

FIGS. 4A to 4D illustrate raising and locking of a safety railing.

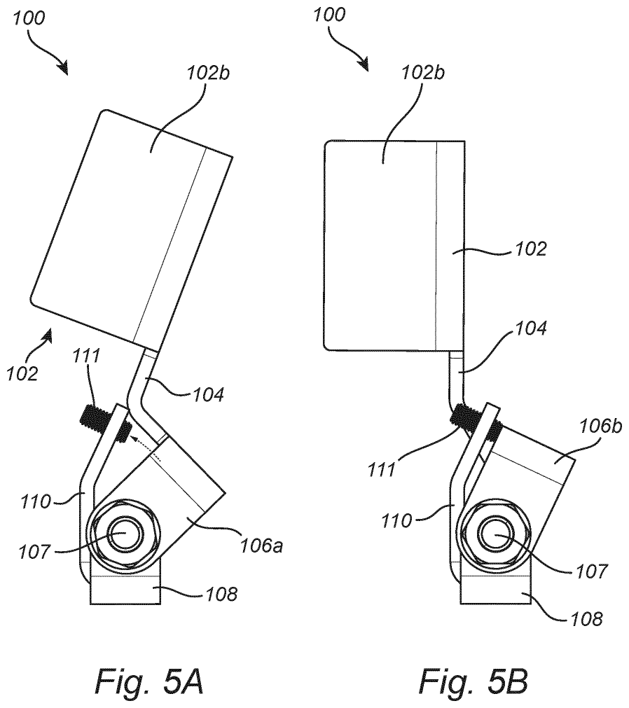

FIGS. 5A and 5B show a first embodiment of a locking device.

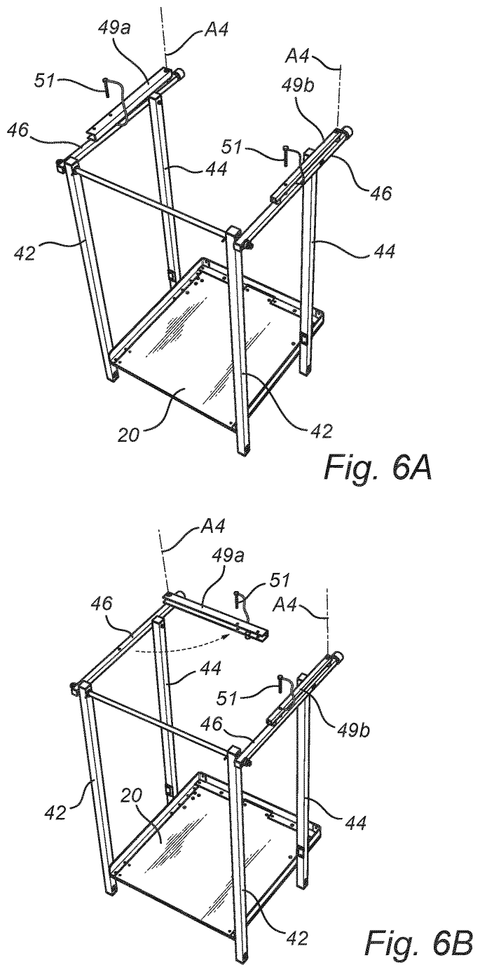

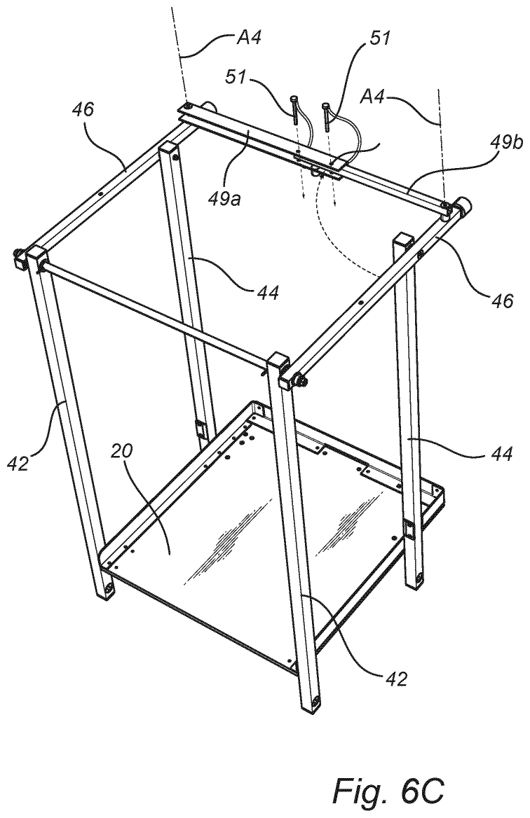

FIGS. 6A to 6C illustrate the use of a closable front railing bar.

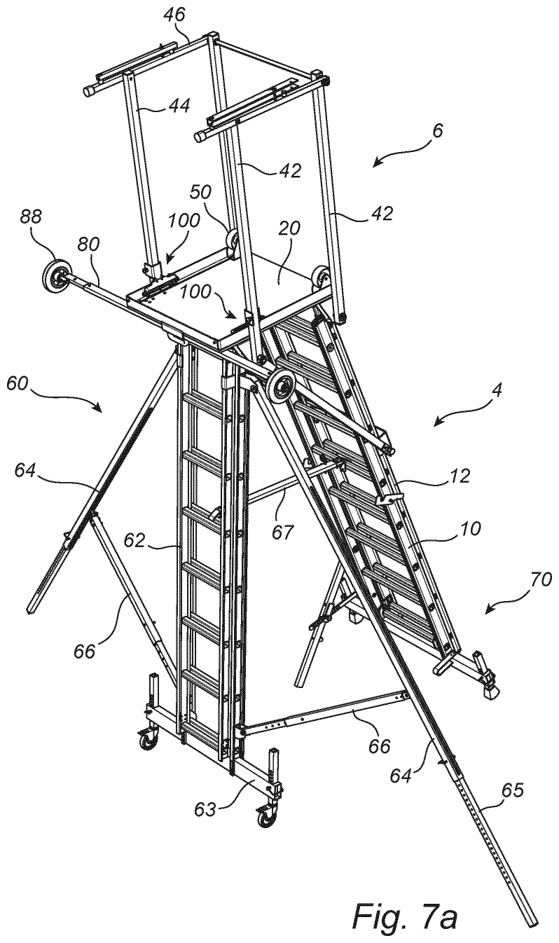

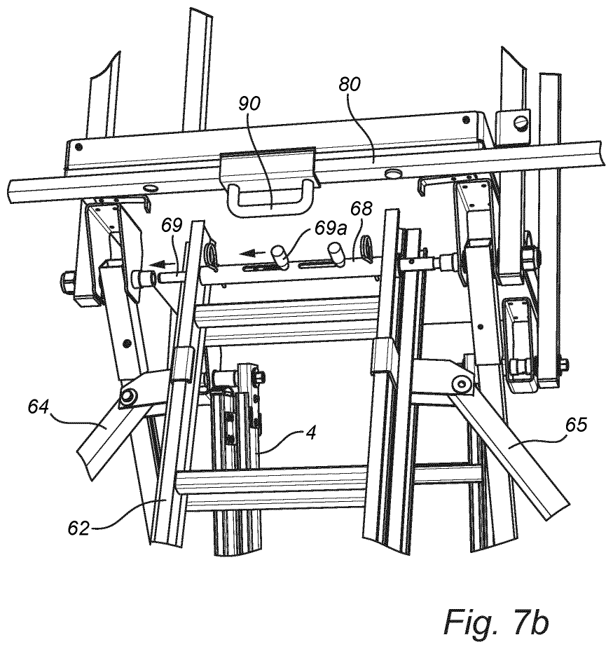

FIGS. 7A and 7B show the apparatus in FIG. 1 provided with an optional accessory for using the apparatus in a free-standing position.

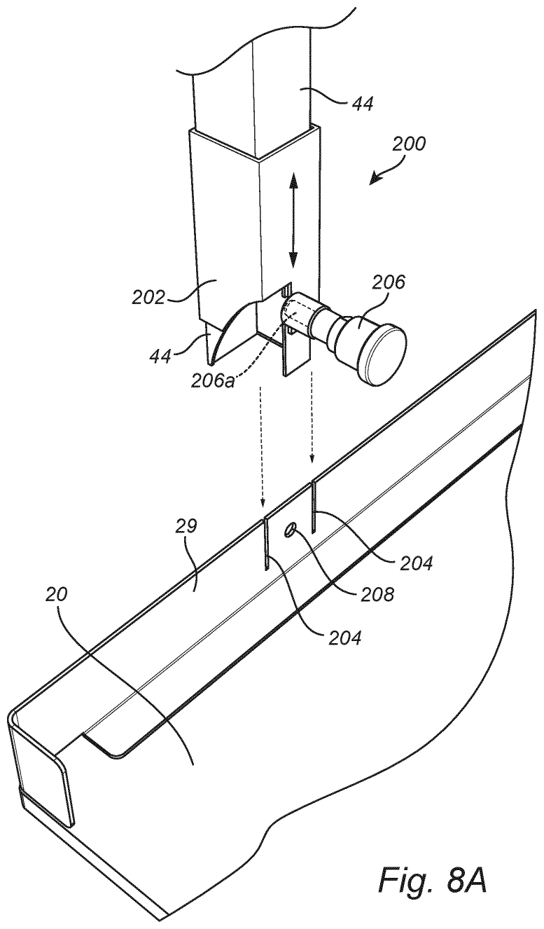

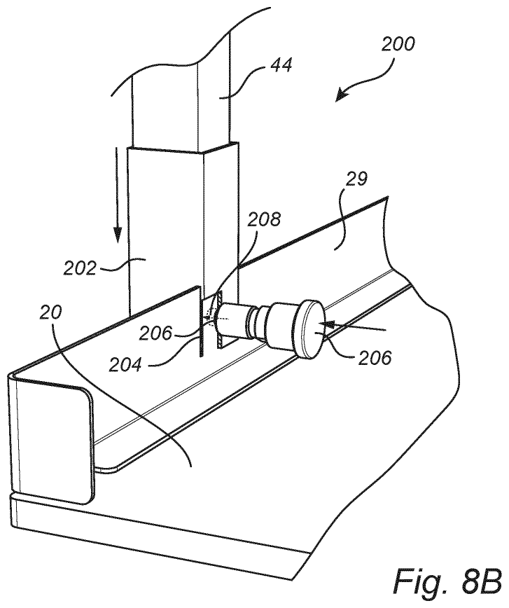

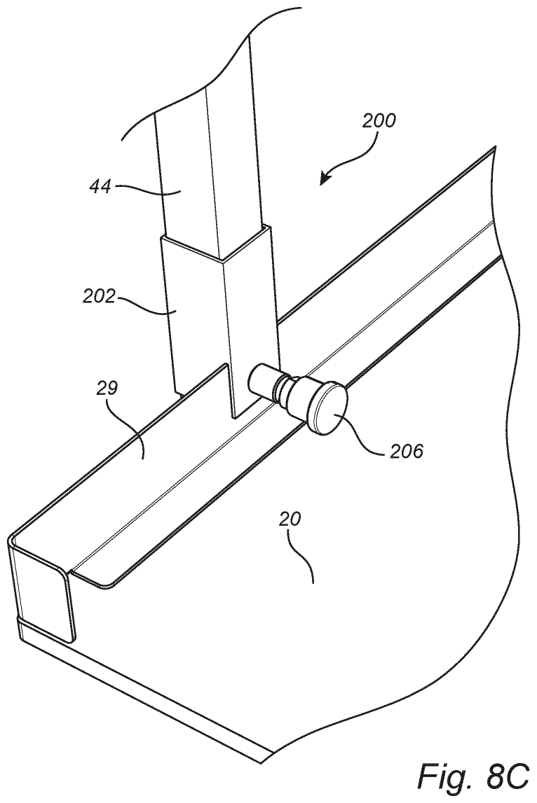

FIGS. 8A to 8C show a second embodiment of a locking device.

The inventive concept for locking a safety railing of a platform ladder apparatus will now for the purpose of exemplification be described in more detailed by means of non-limiting examples, and with reference to the drawings illustrating embodiments and non-limiting examples of the inventive concept. The present invention may, however, be embodied in many different forms and should not be construed as limited to the examples disclosed.

### 1^{st} Embodiment

FIGS. 1A to 1D illustrate an embodiment of a platform ladder apparatus 2. The basic structure of the apparatus 2 is essentially as disclosed in applicant's EP 3 293 345 A1 mentioned above. The apparatus 2 comprises a ladder 4 and a foldable platform assembly 6. The platform assembly 6, which includes at least a working platform 20 and a safety railing 40 arranged at the perimeter of the platform 20, is pivotally connected to an upper end of the ladder 4. FIGS. 1A to 1D show the apparatus 2 in its raised use position standing on the ground G next to a wall W. In the position, the foldable platform assembly 6 is shown it its unfolded, essentially horizontal use position, arranged at an upper end of the ladder 4. FIG. 3 shows the apparatus 2 is in its folded transport position. Pivotable hooks 18 are provided for locking the apparatus in its folded transport position. The platform ladder apparatus 2 may comprise optional transport wheels 50 and a foldable ground support assembly 70. The apparatus would normally be manufactured mainly from alumina. Other materials, such as plastic or wood, are also conceivable.

The ladder 4 may be a telescopic extension ladder comprising a lower ladder section 10 and an upper ladder section 12, each ladder section 10, 12 comprising a number or rungs or steps 14 extending between a pair of rails. As known in the art, the ladder sections 10, 12 may be slidably connected to each other by external guide brackets 16, such that the ladder sections 10, 12 can be slid together for transport and storage, or slid apart to expand the length of the ladder 4 in the use position of the apparatus 2. The ladder sections 10, 12 may be held or locked in their expanded position in different ways as known in the art. The ladder 4 may optionally be provided with pulley-rope means or the like (not shown) to be operated by a user for performing the ladder extraction/retraction. As an alternative, the ladder 4 may also be a straight ladder built in one section.

In FIGS. 1A to 1D, the apparatus 2 is shown in its use position standing on a ground G and leaning by an angle (e.g. 16 degrees) against a wall W or a surface, with a climbing side of the ladder 4 facing away from the wall W and a backside of the ladder 4 facing towards the wall W.

As shown in enlarged scale in FIGS. 2A and 2B, the platform assembly 6 comprises a working platform 20 defining a floor for a user working on an elevated level, and foldable safety railing 40 providing a safety barrier for the user standing or working upon the platform 20. In the use position of the apparatus 2, the platform 20 would normally be essentially horizontal although a minor angle also would be possible.

The working platform 20 may have a rectangular shape as in the present embodiment, although other shapes are possible, such as square shape, partly rounded shapes and all rounded shapes. The platform 20 presents, when viewed by a person standing on the climbing side of the ladder 4 in the use position of the apparatus 2 and facing the wall, a proximal rear side 22, an opposite distal front side 24, a right side 26, and a left side 28.

As illustrated in this embodiment, the platform 20 may be provided with an upright safety border 29, termed “platform rim” in the following, extending along its front side 24 and along its right and left sides 26, 28, but not at the rear entry side 22.

The platform 20 is pivotally connected to the upper end of the ladder 4, in this embodiment the upper end of the upper ladder section 12, for pivotal movement in relation to the ladder 4 about a first axis A1, which is parallel to the rungs 14 and located at the rear side 22 of the platform 20. The first axis A1 is located below the platform 20, at a distance D1 from the platform 20. The distance D1 may be implemented by pivot brackets 21 supported by the platform 20 at the rear side 22 thereof. A first advantage obtained by arranging the first axis A1 at the distance D1 below the platform 20 relates to the operation of folding the apparatus 2 into its transport position. The distance D1 allows the platform 20 to be folded over the lower ladder section 10 of the retracted ladder 4 in the stowed transport position of the apparatus 2 in FIG. 3, resulting in compact dimensions of the apparatus 2 in its transport position. A second advantage obtained by arranging the first axis A1 at the distance D1 below the platform 20 is an increased stability of the safety railing 40, as will be described further below.

The apparatus 2 further comprises a pair of struts 30 for maintaining the platform 20 in the desired angle (horizontally) in relation to the ladder 4 in the use position of the apparatus 2. Each strut 30 is slidably as well as pivotably connected to the ladder 4 at brackets 35. During unfolding of the apparatus 2, each strut 30 is slides and rotates in relation to the bracket 35. When the use position is reached, a locking pin 38 at the lower end of the strut 30 click-locks with the bracket 35 to lock the strut 30 to the bracket 35. The locking pin 38 may be spring-loaded and biased towards its locking position. An upper end 31 of each strut 30 is pivotably connected to the platform 20. The upper connection of the struts 30 to the platform 20 is implemented by a pair of downwardly projecting brackets 32 defining a second pivot axis A2 at a distance D2 below the platform 20. The upper end 31 of each strut 30 is pivotally connected to an associated pivot bracket 32 by a pivot member 34.

Referring to FIGS. 2A and 2B, the foldable safety railing 40 of the foldable platform assembly 6 will now be described in the illustrated use position of the apparatus 2. The safety railing 40 may be arranged along the perimeter and rim 29 of the platform 20. The railing 40 comprises a pair of proximal rear posts 42 arranged at the rear right and rear left corner, respectively, of the platform 20, and a pair of distal front posts 44 arranged as illustrated further towards the front side 24 of the platform 20 at the right and left platform sides, respectively. The posts 42, 44 would normally be essentially vertical in the use position. A lower end of each rear post 42 is pivotally connected at the brackets 21 at the distance 1D from the platform 20, for pivotal movement about the first axis A1. Similarly, a lower end of each front post 44 is pivotally connected to an associated one of the pivot members 34 held by the brackets 32 for pivotal movement about the second axis A2.

The front posts 44 may be arranged at the front corners of the platform 20. However, it may be preferred to arrange the front posts 44 as illustrated at a certain horizontal distance from the front corners of the platform 20. This will create an advantageous workspace between the posts 44 and the wall in the use position.

In addition, the safety railing 40 comprises a pair of upper side rails 46 which pivotally interconnect the two right posts 42, 44 and the two left posts 42, 44, respectively, at the upper ends of the posts. In the illustrated embodiment, an upper rear rail 47, such as a tube or the like, interconnects the upper ends of the rear posts 42. Each side rail 46 may extend distally beyond the front posts 44, and may be provided with a revetment 46a at its distal end facing the wall W. The purpose of the revetments 46a will be described below. The revetments 46a may optionally be designed as small wheels or rollers.

The safety railing 40 further comprises a left and a right upper front rail parts 49a, 49b, which are rotatably connected to the left and right side rails 46 for rotation about axis A4 between an open position (FIG. 6A) and a closed position (FIG. 6C). When the safety railing 40 has been unfolded into its use position as shown in FIG. 6A, the front rail parts 49a, 49b are manually swung towards each other (FIG. 6B) and interconnected by locking pins 51, such that they together form an upper front rail 49a, 49b between the front railing posts 44, similar to the upper rear rail 47 between the rear railing posts 42.

It will be appreciated that each one of the right-hand side and the left-hand side of the safety railing 40 is constructed as a foldable parallelogram, as best shown in the partly folded position of the safety railing 40 in FIG. 4A, in which the posts 42, 44 are pivoted about the pivot axis A1 and A2, respectively.

In order to secure the railing 40 in its upright use position in a quick and user-friendly but still secure manner, i.e. to prevent rotation posts 42, 44, there is provided a locking device 100 for at least one left post and one right post. In the illustrated embodiment, there is one locking device 100 for each one of the front posts 44. As an alternative, the locking devices 100 may be arranged at the rear posts 42 instead. As a further alternative, there may be a locking device for each post 42 and 44.

Reference is now made to FIGS. 4B to 4D, and FIGS. 5A and 5B. Each locking device 100 is structured and arranged to form a releasable mechanical locking connection between its associated post 44 and the platform 20, by direct or indirect contact with the post 44 and the platform 20, to prevent rotation of the post 44 about axis A2. In the first embodiment of the locking device 100 illustrated in said figures, each locking device 100 comprises a movable U-shaped locking member 102 having a front engagement part 102a and a rear engagement part 102b spaced from the front engagement part 102a. The moveable locking member 102 is preferably made of a rigid metal. The locking member 102 may be an elongate rigid member having a cross section in the shape of a U, wherein the legs of the U form the front engagement part 102a and the rear engagement part 102b. The distance between these parts may corresponds essentially to the corresponding dimension of the front post 44.

The locking device 100 further comprises a hinge mechanism 104, 106, 108 by which the movable locking member 102 is rotatably connected to the platform 20, for rotation about an axis A3 extending in a rear-front direction of the platform 20. The hinge mechanism comprises a stationary U-shaped first hinge part 108, the base of which is secured by bolts or screws to the upper side of the platform 20, adjacent the rim 29 and the front post 44. The hinge mechanism further comprises a rotatable U-shaped second hinge part 106, which has two legs 106a and a base 106b. The legs 106a are rotatably connected to the stationary first hinge part 108 via an axle 107. The base 106b of the rotatable second hinge part 106 is connected to the movable locking member 102 via a bent intermediate part 104. In the illustrated embodiment, the locking member 102 is made in one piece with the intermediate part 104 and the second hinge part 106, preferably from a rigid metal material. From FIG. 5B it will be appreciated that the intermediate part 104 allows the locking member 102 to be correctly positioned laterally outside the platform 20 to lock the post 44.

The locking device 100 is optionally provided with at least one spring 109, which in this embodiment is mounted on the axle 107 and is arranged to bias the movable locking member 102 towards the platform 20. In this embodiment, the spring 109 is arranged on the axle 107 and is in a biased condition between the rim 29 and openings 106 in the second hinge part 106. The springs 109 are provided to ensure that the locking devices 100 do not intervene with folding and transporting of the apparatus 2.

The basic locking operation in connection with unfolding the apparatus 2 is illustrated in FIGS. 4A to 4D. After having secured the struts 30 in place at the brackets 35 with the platform 20 forming an angle with the ladder 4, and with the apparatus still lying down on the ground, the user raises the foldable safety railing 40 in relation to the platform 20, as indicated by arrows in FIG. 4A. When the posts 42 and 44 has been pivoted to their correct position in FIG. 4B, the user rotates the locking member 102, against the spring force of spring 109, towards its associated front post 44. As shown in FIG. 4C, the front engagement part 102a will engage with the front side of the front post 44, and the rear engagement part 102b will engage with the rear side of the front post 44. Thereby, the locking member 102 is in its locking position (FIG. 4D) in which the post 44 is pivotably locked in the rear-front direction and is prevented from rotating about the axis A2 away from its locked use position. Obviously, the entire safety railing 40 is then locked in its raised position. When folding the apparatus back to its transport position, the reverse procedure is followed.

In preferred embodiments as in the one illustrated, each locking device 100 is also structured and arranged to engage with the associated post 44 to take up laterally outward directed forces/torques acting on the post 44, for example if the user is leaning to the left against the left railing 46, the left locking device 100 will counteract outward movement of the left front post 44. To this end, in addition to said front and rear engagement parts 102a, 102b, the locking device 100 further comprises an additional engagement element which is arranged, when the movable locking member 102 is in its locking position (FIG. 4A), to engage with the post 44 for preventing the post 44 from moving laterally away from the platform 20 in a plane parallel with the first axis A1 and the post 44. Such an engagement may be located on the outer side of the post 44 as illustrated, or it may be in the form of an engagement into an opening in the post 44.

In the illustrated first embodiment of the locking device, such an additional engagement element is in the form of a displaceable locking pin 103. A spring 103b is arranged to bias the locking pin 103 inwards towards its locking position. Referring to FIG. 4C, when the movable locking member 102 is rotated towards the post 44, the locking pin 103 is moved outwards against the spring force 103b such that the post 44 can be received in the locking member 102. When the final position is reached (FIG. 4D), the locking pin 103 is released, and a tip 103a of the locking pin 103 is, in response to the spring force from spring 103b, brought into engagement, directly or indirectly, with the post 44 to prevent the post 44 from moving away from the platform 20. In the illustrated embodiment, this engagement is on the outer side of the post 44. In an alternative embodiment, the tip 103a of the locking pin 103 may instead be brought into locking engagement with the post 44 by being inserted into an opening or hole in the post 44.

With reference to FIGS. 4A and 4B, each post 44 is optionally provided with a front and a rear guide member 45 fixed to the front side and the rear side, respectively, of the post 44. In alternative embodiments, these guide members 45 are dispensed with. The guide members 45 are preferably manufactured from a durable material, such as stainless steel or a durable rigid plastic material. If the guide members 45 are considered to be part of the post 44, the cross-sectional dimension of the post 44 in the rear-front direction is thereby somewhat increased. The front and rear engagement parts 102a and 102b of the movable locking member 102 may have a corresponding mutual distance, such that the engagement parts 102a, 102b engage with the post 44 indirectly via the guide members 45. For stability purposes there should be a rather tight fit, preferably not more than 0.5 mm between the locking member 102 and each guide member 45, to obtain a good stability. Each guide member 45 has an inclined guide ramp 45a. Thereby, as shown in enlarged scale in FIG. 4C, the locking pin 103 is automatically pushed outwards by the guide ramp 45a when the locking member 102 is rotated towards the post 44, forming a manually releasable snap-lock mechanism. Also, the two guide ramps 45a together assist in guiding the post 44 correctly into the locking member 102, especially in case the post 44 has not been completely rotated into its correct position. In a simpler alternative, a guide member 45 is arranged only on the side where the locking pin 103 is provided.

The illustrated first embodiment of the locking device 100 further comprises a bracket 110, preferably made from rigid metal. The bracket extends up along the inner side of the rim 29 of the platform 20 and is arranged to reinforce the rim 29, especially to assist in taking up forces on the rim 29 from the post 44, if the latter is for some reason pressed inwards towards the platform 20. The bracket 110 also has the function of supporting an adjustment screw 111. As best shown in FIGS. 5A and 5B, the adjustment screw 111 is arranged to engage the base part 106 of the second hinge part 106 when the locking member 102 is in its locking position in FIG. 5B, and is adjusted to form a rotational stop when the locking member 102 has reached its correct locking position. In alternative embodiments, the two functions of reinforcing the platform rim 29 and forming a rotational stop can be implemented by separate means, one for each function. It will be appreciated that in embodiments where the rotational locking member 102 comprises said additional engagement element for lateral stabilization of the railing post 44, some form of rotational stop would be necessary for preventing the rotatable locking member 102 from rotating beyond its locking position.

The distances D1 and D2 provides an increased stability of the raised safety railing 40 in the right-left direction. If a user standing on the platform 20 leans for instance against the right side of the safety railing 40, e.g. against the right-hand upper side rail 46, this will create a right-hand directed force on the two right posts 42, 44. This right-hand directed force will be transferred in part via the rear railing 47 from the right rear post 42 to the left rear post 42, and via the front railing 49a, 49b from the right front post 44 to the left front post 44. Due to the manner in which the posts 42, 44 are pivotably mounted at the distances D1, D2 below the platform 20, each one of the left rear post 42 and the left front post 44 will in this situation act as a lever and the platform 20 will act as the fulcrum (pivot point) for this lever. Accordingly, since the lower end of the lever is connected at a distance D1/D2 the fulcrum 20, the force will effectively be counter-acted by an opposite left-hand directed force, resulting in a very stable safety railing construction. The similar effect applies obviously in the other direction if a load is applied on the left side of the railing 40. The effect is that the railing 40 is effectively stabilized compared to a design where the lower ends of the posts 42 would have been fixed only in level with the platform. This technical effect forms the subject-matter of applicant's granted divisional application EP 3 572 610 A1.

In the illustrated embodiment, the connection means arranged at the first axis A1 serves dual purposes, namely for creating the pivotal connection between the platform 20 and the ladder 4, and for connecting to the lower ends of the rear posts 42 for obtaining the lever action. This provides a compact and cost effective solution for obtaining both effects. In alternative embodiments, a separate axis may be provided for each one of the two functions.

To summarize, this design of the railing 40 and the lever function of the posts 42, 44 has the advantage that the railing structure is foldable as well as very stable in the use position, a combination which is generally difficult to obtain in foldable structures.

In order to enhance the stability of the apparatus 2 in its use position, the platform assembly 6 is further provided with left and right stabilizing support arms 80, as previously known from applicant's above-mentioned EP 3 293 345 A1 to which reference is made for a structural and functional detailed description relating to these arms 80. Each arm 80 is rotatably connected to the platform 20 at the front platform side 24 for rotational movement in a plane parallel to the platform 20. The longer the arms, the better stability may be obtained. Preferably, the outer end of each arm—or any member attached to the outer arm end—will have contact with the wall in the use position of the apparatus. In some embodiments, these two contact points will be the only wall contact points of the apparatus. In other embodiments, there may be one or more further points or areas of wall contact, such as at the platform 20. Such further contact points may be points of direct contact or points of indirect contact via wheels or rollers. The arms 80 are manually movable between:
a stowed arm position (FIG. 3) in which the arms 80 project out from the front side 24 of the platform 20, typically at least partially or essentially completely along a rear-front direction perpendicular to the first axis A1, thereby effectively preventing use of the apparatus as a result of the arms 80 preventing the platform 20 from be positioned correctly in relation to the wall W, and
a stabilizing arm position (FIGS. 1A to 1D) in which the arms 80 project sideways from the platform 20 in opposite right and left directions, respectively, for stabilizing the apparatus 2 in relation to the wall W.

The design, connection and movability of the stabilizing wall support arms 80 provide the apparatus 2 with a safety and stabilization feature which cannot be set aside by the user due to oversight or lost components. The arms 80 cannot be removed and lost, so the user does not have to locate and mount the arms when erecting the apparatus 2. More important, the design is such that the arms 80 effectively prevent any use of the apparatus unless they have been brought to their stabilizing arm position. In other words, the arms 80 have a dual function: they give stability in the use position of the apparatus 2 and they prevent use of the apparatus 2 if the stability function is not activated.

In the illustrated embodiment, each arm 80 is provided with a wheel or roller 88 at an outer end of the arm 80 for engaging the wall W in the use position of the apparatus. In other embodiments of the apparatus, the arms 80 may be provided with other contact means instead of wheels 88 or in addition to the wheels 88. As shown in the illustrated embodiment, each arm 80 has, as an option, an adjustable length, for instance by using telescopic arms, in order to suitably adjust the point of contacts of the wheels 88 against the wall W.

As mentioned above, the illustrated embodiment of the apparatus also comprises a ground support assembly 70, designed to prevent the apparatus from sliding away from the wall W. For a detailed description of the ground support assembly 70 and its operation, reference is made to the above-mentioned patent applications.

The apparatus 2 as described above is used and unfolded in the manner to be described. Using the following correct sequence of unfolding steps allows the user to climb up the apparatus within less than 30 seconds from starting from the transport position in FIG. 3.

The apparatus 2 is initially transported in its folded transport position (FIG. 3) to the site where it is to be used. Especially, the apparatus 2 may be rolled on the ground on the transport wheels 50 with the orientation in FIG. 3, and placed on the ground at the location where it is to be unfolded.

With the ladder parts 10 and 12 locked together and the locking hooks 18 unlocked, the ladder 4 is rotated upwards from the platform 20 about the first axis A1. The bottom end of the ladder 4 is now pointing upwards. In response to this rotation of the ladder 4, each strut 30 automatically slides in relation to its associated bracket 35. When the correct angle between the ladder 4 and the platform 20 has been reached, the angle is automatically fixed by locking pins 38 snap-locking the struts 30 in relation to the brackets 35. In the illustrated embodiment, this occurs when the ladder 4 has been rotated about 105 degrees from its folded transport position. In this position, the safety railing 40 is still unfolded.

With the angle now fixed between the ladder 4 and the platform 20 by the struts 30, the ladder 4 is rotated further by the user, now downwards. This will make the platform 20 pivot upwards from the ground, whereby the folded safety railing 40 begins to automatically unfold from the platform 20. The user continues to rotate the ladder 4 until the ladder 4 reaches the ground. The ladder 4 has now been rotated about 180 degrees from the folded transport position in FIG. 3. In this position, the safety railing 40 has been almost, but not entirely unfolded. It still needs to be finally unfolded the remaining angle to its correct lockable position.

Next, the arms 80 are rotated out to their position of use.

The unfolded safety railing 40 is now to be locked. First, the user lifts the platform assembly 6 by using a handle 90 on the rear side of the platform (FIGS. 2B and 3) until the front posts 44 have been pivoted the final angle to their correct raised and lockable position in relation to the platform 20. In this position, the user can then lock each one of the two front posts 44 by rotating the respective locking device 100 to their locking position as previously described in relation to FIGS. 4B to 4D. The guide members 45 on the front and rear sides of the posts 44 will guide the U-shaped locking members 102 to their correct position. The locking pins 103 snap-locks the safety railing 40 in relation to the platform 20.

Next, the ground support assembly 70 is unfolded. It may be noted that both the ground support assembly 70 and the stabilizing support arms 80 constitute safety devices for stability which cannot be set aside by the user. The apparatus 2 cannot be correctly raised unless the ground support assembly 70 is correctly unfolded. If not unfolded, the apparatus 2 cannot stand correctly on the ground.

Thereafter, the unfolded and locked (ready-to-use) apparatus 2 is raised against the wall W as shown in FIG. 1A, using the wheels 88 on the arms 80 to raise the apparatus 2. The position of the platform 20 can now be adjusted to a suitable work level by extending the upper ladder section 10, while the wheels 88 will be rolling against the wall W. Next, the ladder sections 10, 12 are locked in relation to each other by the hooks 18. The lower part of the ladder 4 is then adjusted on the ground G such that the platform 20 becomes horizontal. The revetments 46a of the upper side rails 46 will then be at a distance from the wall W as shown in FIG. 1C. The ground support 70 is now also adjusted in relation to the ground G and fixed.

If for some reason the frictional forces against the wall W and/or the ground G should be insufficient, and an initial sliding movement should occur at the points of contact, for instance due to dynamic forces acting on the apparatus 2, then the ground support 70 will be pressed harder against the ground G with a resulting increase of frictional forces in relation to the ground G, which will counteract the sliding movement of the apparatus 2. More important though, the ground support assembly 70 will create a geometrical pivot point for the apparatus 2 counteracting further movement of the apparatus 2 away from the wall W. If the apparatus 2 nevertheless should continue its sliding movement, then the distance at the revetments 46a (see FIG. 1C) will be gradually reduced and the revetments 46a will eventually be brought into contact with the wall W, resulting in an additional frictional forces counteracting the sliding movement. If the revetments 46a should be brought into contact with and press against the wall W, a new geometric structure is obtained in which the apparatus is supported against the wall at a higher level. In fact, the whole “ladder” becomes longer which, in its turn, results in a reduction of the forces which tend to make the apparatus slide. This technical effect forms the subject matter of applicant's divisional application EP 3 995 665 A1.

FIG. 7 illustrates the above described apparatus 2 provided with an optional accessory 60, allowing the user to use the apparatus 2 also as a free-standing apparatus 2, essentially like mobile ladders with platforms. In this way, the inventive apparatus 2 may be used both outdoors against walls, and indoors as a free-standing apparatus. The accessory comprises a stabilizing structure 62 which is provided with optional wheels at reference 63, and which is pivotably connected to the platform 20 at its upper end. For stability reasons, the first ladder 4 and the stabilizing structure 62 are releasably interconnected by an interconnecting strut 67. Although the stabilizing structure 62 may visually appear as a second ladder in FIG. 7A, it should be noted that it is not intended to be used as such.

The accessory 60 further comprises optional stabilizing right and left ground supports 64, 65. In the illustrated embodiments, the ground supports 64, 65 are telescopic to be adjustable in length. The upper ends of the ground supports 64, 65 are pivotably connected to the second ladder 62 as best seen in FIG. 7B, such that they may be unfolded to the stabilizing position shown in FIG. 7A. They may be locked in their position of use by struts 66. The struts 66 are preferably telescopic such that their length may be adapted to different relative positions of the ladder parts 10 and 12, in order to avoid a to large width of the accessory 60.

The user can connect and disconnect the optional accessory 60 depending on intended use of the apparatus. FIG. 7B illustrates how the accessory 60 may be releasably connected to the apparatus 2. The upper end of the second ladder 62 comprises a tube 68 in which two locking rods 69 are slidably received. Each locking rod 69 is manually displaceable by means of a grip 69a extending out through an opening in the tube 68. The locking rods 69 are designed to be slidably received in the pivot members 34 located at the axis A2. In FIG. 7b, the right locking rod 69 is shown in its locked position inside the pivot member 34, while the left locking rod 69 is shown in its retracted non-locking position. Security means are illustrated in FIG. 7B for securing the locking rods 69 in their locking position.

Reference is now made to FIGS. 8A to 8C, illustrating the telescopic embodiment of a locking device 200. In the telescopic embodiment, the railing post 44 is used as the mechanical guide for the movable locking member 200. In the telescopic embodiment, the movable locking member 200 is a linearly displaceable or slidable locking member, and is slidably supported by the associated railing post 44 as shown in FIGS. 8A and 8B for linear movement along the railing post 44 between the non-locking position (FIG. 8A) and the locking position (FIGS. 8B and 8C). The locking member has an inner cross-section essentially corresponding to the outer cross-section of the railing tube 44.

The locking member 202 is located closer to the platform 20 in the locking position compared to the non-locking position. The locking member 202, when it is in its locking position, is prevented from moving or rotating in a plane perpendicular to the post pivot axis A2, i.e. in a rear-front direction. In the illustrated embodiment, this is implemented by the slidable locking member 202, when it is in its locking position, is in indirect mechanical engagement with the platform 20 via the platform rim 29. The rim 29 may be enforced for this purpose. The rim 29 is provided with two locking grooves or locking slits 204, which are arranged to receive lower parts of the locking member 202 in response to the latter being moved towards the platform 20. In the locking position shown in FIGS. 8B and 8C, a tip 206 of a displaceable locking pin 26 is inserted through an opening 208 in the rim 29 to secure the locking member 202 in its locking position. It will be appreciated that the laterally outer side (not shown in the figures) of the tubular locking member 202 will form the additional engagement element which prevents outward movement of the railing post 44 away from the platform 20.

1. A ladder platform apparatus comprising:
a ladder;
a working platform having a rear side at which the working platform is rotatably connected to the ladder, and an opposite front side;
a foldable safety railing having a left and a right lockable railing post rotatably mounted at a left side and a right side, respectively, of the working platform for rotation about a post pivot axis located below the working platform between a folded transport position, and a lockable raised position in which each railing post presents an upper part located above the working platform and a lower part located below the working platform; and
a left and a right locking device associated with the left railing post and the right railing post, respectively, each locking device comprising a movable locking member which has a front engagement part and a rear engagement part spaced from the front engagement part, and which is arranged to be moved in relation to the working platform as well as its associated railing post between
a non-locking position in which the associated railing post is free to rotate about the post pivot axis in relation to the working platform, and
a locking position in which the front engagement part and the rear engagement part of the locking member is in engagement with a front side and a rear side, respectively, of the upper part of the associated railing post, and in which the locking member is prevented from rotating in relation to the working platform about the post pivot axis, thereby preventing the railing post from rotating about its post pivot axis away from its locked raised position.

2. The ladder platform apparatus according to claim 1, wherein the movable locking member further has an additional engagement element; and wherein, when the locking member it is in its locking position in engagement with the associated railing post,
the locking member is prevented also from moving laterally away from the platform, and
said additional engagement element is in engagement with the railing post for preventing the railing post from moving laterally away from the locking member and, thereby, laterally away from the platform.

3. The ladder platform apparatus according to claim 1, wherein the movable locking member is a rotatable locking member, and wherein each locking device 100 further comprises a hinge mechanism by which the locking member is rotatably connected to the working platform for rotation about a hinge axis extending in a rear-front direction of the working platform, wherein the associated railing post is out of engagement with the locking member in the non-locking position of the locking member, and wherein the associated railing post is received between the front engagement part and the rear engagement part of the locking member in response to the locking member being rotated about the hinge axis towards the railing post.

4. The ladder platform apparatus according to claim 3, wherein each locking device, in order to prevent the locking member, when it has been rotated into its locking position, from rotating further laterally away from the safety platform, further comprises a rotational stop means defining a rotational stop for the rotatable locking member.

5. The ladder platform apparatus according to claim 3, wherein the rotatable locking member comprises an elongate rigid member having a cross section in the shape of a U, wherein legs of the U form the front engagement part and the rear engagement part, respectively, of the rotatable locking member, and wherein the associated railing post is received into an open side of the U in response to the rotatable locking member being rotated towards the railing post.

6. The ladder platform apparatus according to claim 3, wherein said additional engagement element (103) for preventing the associated railing post from moving laterally away from the locking member, comprises a displaceable engagement element, such as a locking pin, which is mounted on the front engagement part or the rear engagement part and which is displaceable between an unlocking position in which it is not in engagement with the railing post, and a locking position in which it is in engagement with the railing post for preventing the railing post from moving laterally away from the locking member and, thereby, from the platform.

7. The ladder platform apparatus according to claim 6, wherein said displaceable engagement element, when it is in its locking position, is in engagement with a laterally outer side of the associated railing post.

8. The ladder platform apparatus according to claim 1, wherein the movable locking member is a linearly displaceable locking member and is slidably supported by the associated railing post for linear movement along the railing post between the non-locking position and the locking position, and wherein the locking position is a position closer to the platform than the non-locking position.

9. The ladder platform apparatus according to claim 1, wherein the movable locking member, when it is in its locking position, is located at a lower end of the upper part of the associated railing post, at a distance from a top end of the railing post.

10. The ladder platform apparatus according to clam 1, wherein each locking device comprises a security member, such as a snap-lock member, arranged to secure the movable locking member in its locking position.

11. The ladder platform apparatus according to clam 1, wherein each locking device comprises a spring member arranged to bias the movable locking member towards its non-locking position.
